(19) United States
(12) Patent Application Publication
(10) Pub. No.: US 2016/0112935 A1
(43) Pub. Date: Apr. 21, 2016

(54) REDUCING A CONNECTION TIME FOR SAVED-PROFILE ACCESS POINTS

(71) Applicant: QUALCOMM Incorporated, San Diego, CA (US)

(72) Inventors: Sachin Ahuja, Hyderabad (IN); Ganesh Kondabattini, Hyderabad (IN); Ganesh Babu Kumaravel, Hyderabad (IN); Kiran Neelisetty, Hyderabad (IN)

(21) Appl. No.: 14/516,432

(22) Filed: Oct. 16, 2014

(51) Int. Cl. H04W 48/16; H04W 84/12

(52) U.S. Cl. CPC H04W 48/16; H04W 84/12

(57) ABSTRACT

A method of operating a user station (STA) to scan for access points (APs). The STA broadcasts a probe request on a first saved channel of one or more saved channels. More specifically, each of the one or more saved channels corresponds to a channel on which the STA had prior communications with an AP. The STA remains on the first saved channel for an extended duration to listen for a probe response from a first AP. Specifically, the extended duration is greater than a dwell time of the STA when scanning wireless channels other than the one or more saved channels.

### TECHNICAL FIELD

The present embodiments relate generally to wireless networks, and specifically to reducing a connection time between user stations and access points.

### BACKGROUND OF RELATED ART

A wireless local area network (WLAN) may be formed by one or more access points (APs) that provide a wireless communication channel or link with a number of client devices or stations (STAs). Each AP, which may correspond to a Basic Service Set (BSS), periodically broadcasts beacon frames to enable any STAs within wireless range of the AP to establish and/or maintain a communication link with the WLAN. When a STA becomes associated with (e.g., connected to) an AP, the STA typically stores a service set identifier (SSID) of the AP in memory to facilitate subsequent connections to that AP (e.g., hereinafter referred to as a “saved-profile AP”).

When attempting to establish a connection with (e.g., reconnect to) a saved-profile AP, the STA typically scans all available wireless channels (e.g., in the 2.4 Ghz and/or 5 Ghz frequency ranges) for any APs matching a stored SSID. More specifically, the STA may broadcast a probe request on each of the available channels and listen for a probe response from the AP. If, after scanning all available channels, the STA does not receive a probe response from any of the saved-profile APs (e.g., due to congestion and/or interference on the channels), the STA may initiate another full scan.

Scanning all available channels consumes significant power and time. Moreover, the frequency with which this scan is performed may vary, for example, from 15 seconds (e.g., if the STA is not connected to an AP) to 2 minutes (e.g., if the STA is connected to an AP). Thus, if the STA misses or otherwise fails to receive a probe response on a particular channel, it may have to wait a given duration before performing a subsequent scan of that channel.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method of operating a user station (STA) to scan for access points (APs) is disclosed. The STA broadcasts a probe request on a first saved channel of one or more saved channels. More specifically, each of the one or more saved channels corresponds to a channel on which the STA had prior communications with an AP. The STA remains on the first saved channel for an extended duration to listen for a probe response from a first AP. Specifically, the extended duration is greater than a dwell time of the STA when scanning wireless channels other than the one or more saved channels.

In some instances, the STA may not receive a probe response within the extended duration. If the STA determines that a second saved channel of the one or more saved channels has not yet been scanned, the STA may broadcast a probe request on the second saved channel. The STA then remains on the second saved channel for the extended duration to listen for a probe response. If the STA determines that all of the saved channels have been scanned, the STA may then broadcast a probe request on a first wireless channel that is not among the one or more saved channels. The STA then remains on the first wireless channel for a first duration to listen for a probe response. Specifically, the first duration may be equal to the dwell time.

For some embodiments, the probe request broadcast by the STA may include information specifying a length of the extended duration. Upon receiving such information, the AP may repeatedly transmit probe responses to the STA for the length of the extended duration. Further, for some embodiments, the STA may transmit an acknowledgment (ACK) frame to the AP upon receiving each probe response. For example, the probe response may be encapsulated in an action frame which triggers the STA to respond with the ACK frame. The AP may then stop transmitting the probe response upon receiving the ACK frame from the STA.

A method of operating an AP is also disclosed, whereby the AP receives a probe request from a STA. The probe request includes information identifying a first channel number and a first service set identifier (SSID). The AP compares the first channel number and the first SSID with a respective channel number and SSID associated with the AP, and selectively transmits a probe response to the STA based on the comparison. For example, the AP may transmit the probe response if the first channel number matches the channel number associated with the AP and the first SSID matches the SSID associated with the AP.

For some embodiments, the AP may encapsulate the probe response in an action frame and transmit the action frame to the STA. For example, the action frame may require an acknowledgment (e.g., in the form of an ACK frame) from the STA upon receipt. The probe request may further include information specifying a dwell time of the STA on the first channel. Thus, for some embodiments, the AP may repeatedly transmit probe responses to the STA for the length of the dwell time. The AP may cease transmission of the probe responses upon receiving an ACK frame from the STA.

By increasing the dwell time of the STA when scanning the one or more saved channels, the method of operation disclosed herein may increase the likelihood that the STA receives a probe response from a saved-profile AP. This may further reduce the overall scan time and/or number of attempts needed to establish a connection with the AP. Moreover, enabling the AP to continuously transmit (and retransmit) probe responses for the duration of the STA's dwell time further increases the likelihood that the STA will receive a probe response from a saved AP before leaving the saved channel.

### BRIEF DESCRIPTION OF THE DRAWINGS

The present embodiments are illustrated by way of example and are not intended to be limited by the figures of the accompanying drawings, where:

FIG. 1 shows a block diagram of a WLAN system within which the present embodiments may be implemented.

FIG. 2 is an exemplary timing diagram illustrating a targeted scan of a saved channel, in accordance with some embodiments.

FIG. 3 is an exemplary timing diagram illustrating a dynamic scan operation performed by a STA, in accordance with some embodiments.

FIG. 4 is an exemplary timing diagram illustrating a modified channel scan, in accordance with some embodiments.

FIGS. 5A and 5B are exemplary timing diagrams illustrating modified channel scans, in accordance with other embodiments.

FIG. 6 shows a block diagram of a wireless station (STA) in accordance with some embodiments.

FIG. 7 shows a block diagram of an access point (AP) in accordance with some embodiments.

FIG. 8 shows an illustrative flow chart depicting a dynamic scan operation performed by a STA, in accordance with some embodiments.

FIG. 9 shows an illustrative flow chart depicting a method of operating an AP during a modified scan operation, in accordance with some embodiments.

FIG. 10 shows an illustrative flow chart depicting a modified scan operation, in accordance with some embodiments.

### DETAILED DESCRIPTION

The present embodiments are described below in the context of data exchanges between Wi-Fi enabled devices for simplicity only. It is to be understood that the present embodiments may be equally applicable to data exchanges using signals of other various wireless standards or protocols. As used herein, the terms “WLAN” and “Wi-Fi” can include communications governed by the IEEE 802.11 family of standards, BLUETOOTH® (Bluetooth), HiperLAN (a set of wireless standards, comparable to IEEE 802.11 standards, used primarily in Europe), and other technologies having relatively short radio propagation range. In addition, although described herein in terms of exchanging frames between wireless devices, the present embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). As used herein, the terms “scanning” and “scan operation” may refer to a process by which a mobile device searches for an access point (AP) to connect to (e.g., by broadcasting probe requests), and the term “dwell time” may refer to the duration which the mobile device remains on a particular channel (e.g., to listen for a probe response from the AP) before moving on to the next channel in the scan operation. Further, as used herein, the term “saved-profile AP” may refer to any AP with which a mobile device had prior communications, and the term “saved channel” may refer to a wireless channel on which the prior communications took place.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The present embodiments are not to be construed as limited to specific examples described herein but rather to include within their scope all embodiments defined by the appended claims.

As mentioned above, scanning all available wireless channels when attempting to connect to an AP consumes significant power and time. Moreover, if the STA misses or otherwise fails to receive a probe response on a particular channel, it may have to wait a given duration before performing a subsequent scan of that channel. Thus, conventional scanning operations may be especially inefficient when attempting to connect to a saved-profile AP (e.g., wherein the STA already knows the channel on which the AP should be present). The embodiments described herein address these issues by “dynamically” scanning the available wireless channels in a manner which prioritizes the scanning of saved channels over other wireless channels.

For example, in some embodiments, a STA may first perform a “targeted scan” of one or more saved channels and, if necessary, subsequently perform a full scan of all available (or remaining) channels. More specifically, when performing the targeted scan, the STA may remain on each of the one or more saved channels (e.g., to listen for probe responses) for an extended duration that is longer than a typical dwell time of the STA (e.g., when performing a full scan and/or scanning channels other than the one or more saved channels). This increases the likelihood that the STA will receive a probe response from a saved-profile AP (e.g., on a channel on which the AP is expected to be present), and may further reduce the number of channels that need to be scanned and/or rescanned.

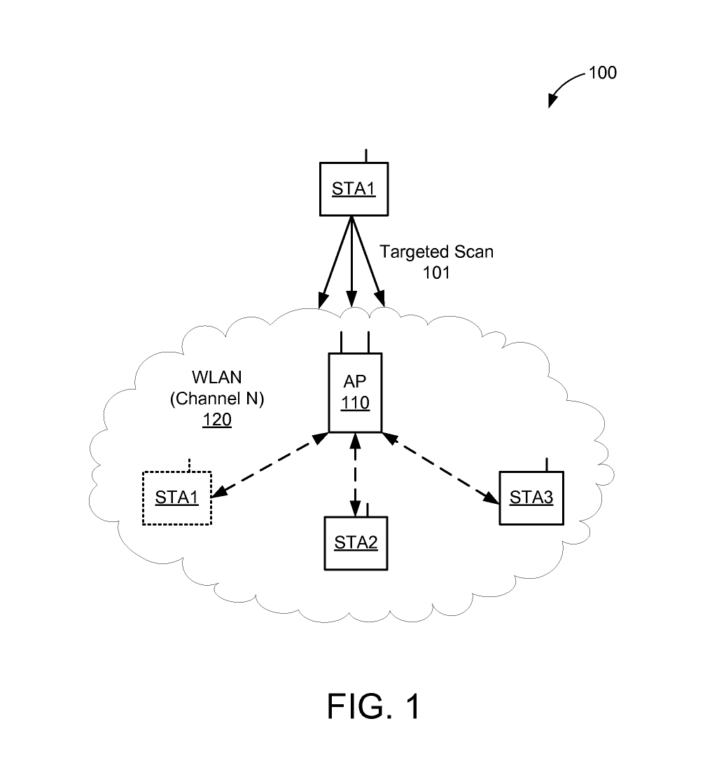

FIG. 1 shows a block diagram of a WLAN system within which the present embodiments may be implemented. The system is shown to include three wireless stations STA1-STA3, a wireless access point (AP) 110, and a wireless local area network (WLAN) 120. The WLAN 120 may “reside” on a particular wireless channel (channel N) of a corresponding frequency band (e.g., the 2.4 Ghz band or 5 Ghz band), and may be identified by a network name commonly referred to as its SSID. More specifically, wireless devices may identify and connect to the WLAN 120 (and more specifically to the AP 110) based on the SSID, and may subsequently communicate with one another (e.g., while connected to the WLAN 120) via wireless channel N.

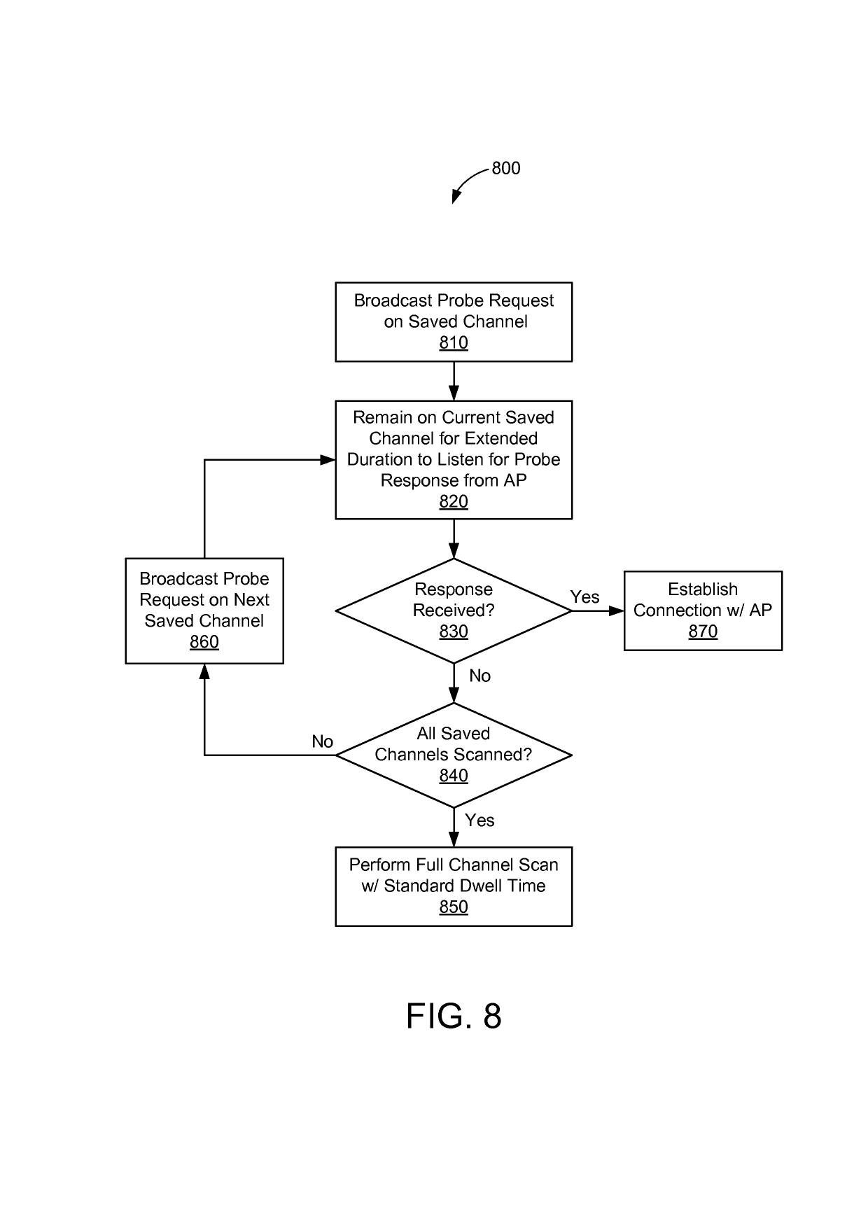

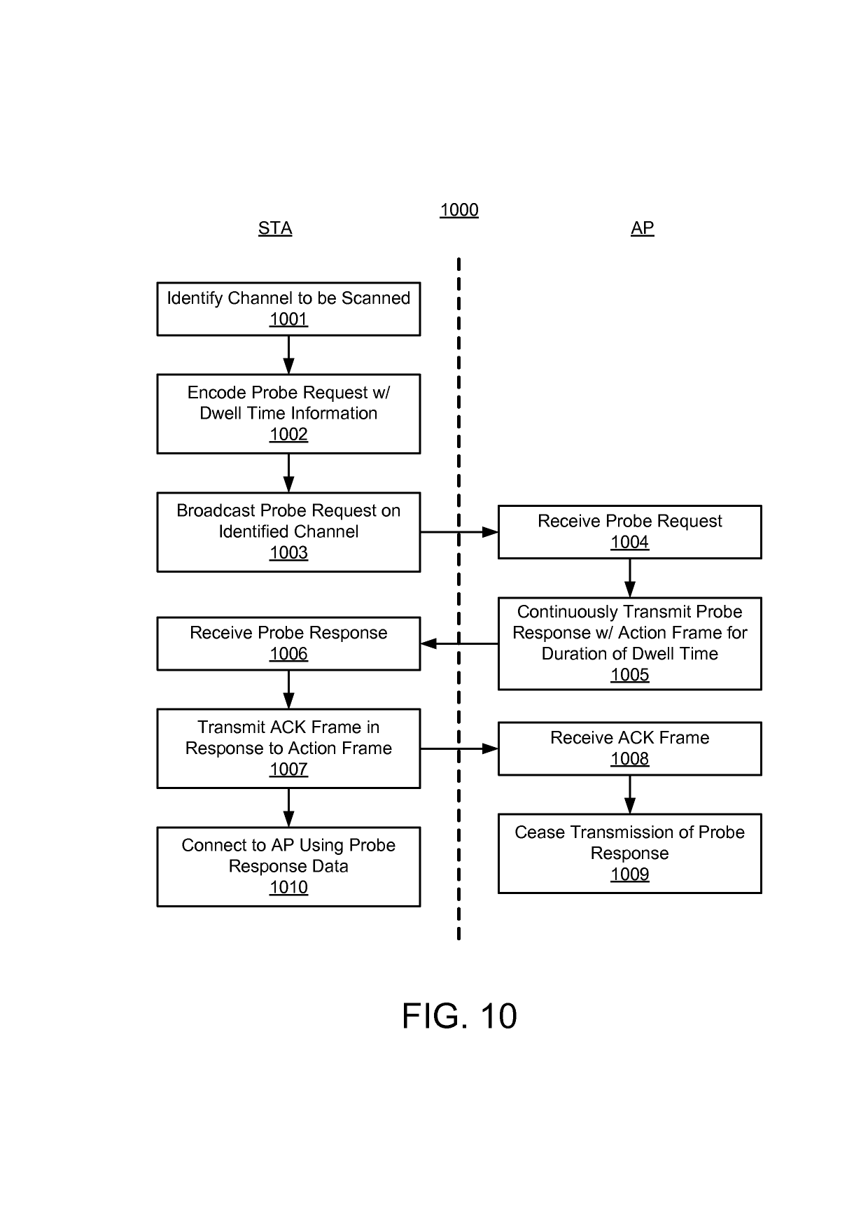

The wireless stations STA1-STA3 may be any suitable Wi-Fi enabled wireless devices including, for example, cell phone, personal digital assistants (PDAs), tablet devices, laptop computers, or the like. For at least some embodiments, the stations STA1-STA3 may include a transceiver, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8 and 10.

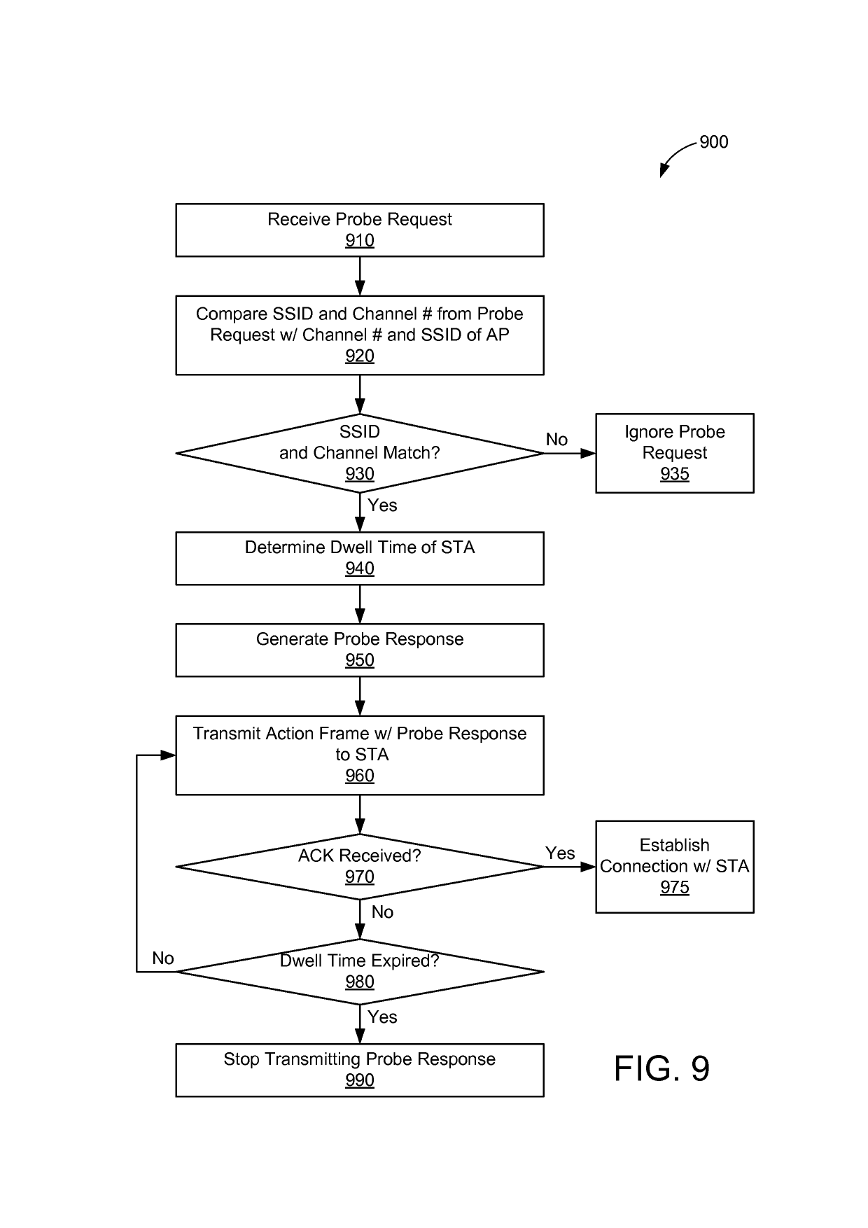

The AP 110 may be any suitable device that allows one or more wireless devices to connect to a network (e.g., a LAN, WAN, MAN, and/or the Internet) via AP 110 using Wi-Fi, Bluetooth, or any other suitable wireless communication protocols. For at least one embodiment, AP 110 may include a transceiver, a network interface, one or more processing resources, and one or more memory resources. The memory resources may include a non-transitory computer-readable medium (e.g., one or more nonvolatile memory elements, such as EPROM, EEPROM, Flash memory, a hard drive, etc.) that store instructions for performing operations described below with respect to FIGS. 9 and 10.

The AP 110 may periodically broadcast beacon frames to enable any STAs within wireless range to establish and/or maintain a communication link with the WLAN 120. A STA may also initiate a connection to the AP 110 by transmitting a probe request to the AP 110. A typical probe request associated with current IEEE 802.11 standards typically include 150 Bytes of information, including several of the following information fields:

1. Service Set Identifier (SSID)

2. Supported Rates

3. Request Information

4. Extended Supported Rates

5. Direct Sequence Spread Spectrum (DSSS) Parameter Set

6. Supported Operating Classes

7. High Throughput (HT) Capabilities

8. 20/40 Basic Service Set (BSS) Coexistence

9. Extended Capabilities

10. SSID List

11. Channel Usage

12. Interworking

13. Mesh ID

14. Multi-Band

15. Directed Multi-Gigabit (DMG) Capabilities

16. Multiple MAC Sublayers

17. Very High Throughput (VHT) Capabilities

18. Vendor Specific Information Elements (VSIEs)

When the AP 110 receives a probe request, the AP 110 responds by sending a probe response that mirrors the information provided in the probe request intersected with the capabilities supported at the AP 110. Thus, for example, when an AP 110 receives a probe request containing a selected number F of the information fields listed above, the AP 110 may send a probe response including the selected number N of the above-listed information fields when all F fields/capabilities are supported by the AP 110. When a STA becomes associated with the AP 110, that STA may store AP profile information (e.g., SSID, PSK, key management information, priority information, etc.) in memory to facilitate subsequent connections to the AP 110.

For some embodiments, the stored profile information may also include saved channel information identifying the wireless channel (e.g., channel N) on which the connection to the AP 110 is established. In the example shown, STA2 and STA3 are currently connected to the AP 110, whereas STA1 is attempting to reconnect to the AP 110. Accordingly, each of the stations STA1-STA3 may store saved channel information identifying channel N. The saved channel information enables STA1 to perform a targeted scan 101 when attempting to reconnect with the AP 110. When performing the targeted scan 101, the STA1 broadcasts beacon frames on only the channel(s) identified by the saved channel information (e.g., channel N). Further, for some embodiments, the STA1 may remain on each saved channel for an extended duration (e.g., dwell time) to listen for a probe response. More specifically, the extended duration may be longer than a standard dwell time of the STA1 when scanning other channels (e.g., other than those identified by the saved channel information).

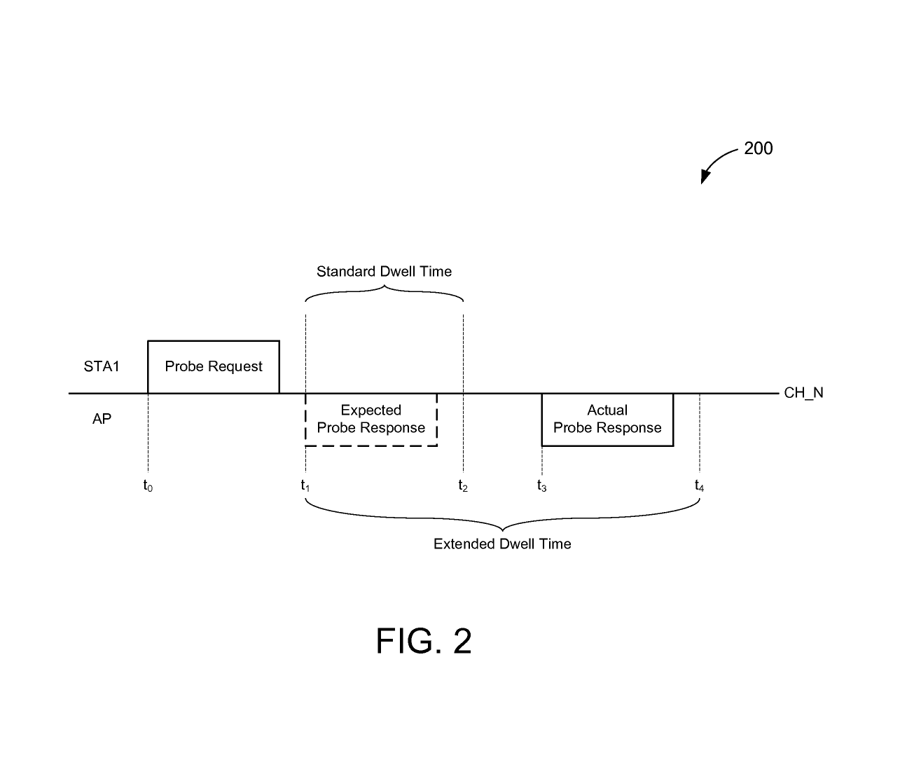

FIG. 2 is an exemplary timing diagram 200 illustrating a targeted scan of a saved channel, in accordance with some embodiments. With reference, for example, to FIG. 1, the STA1 may perform the targeted scan when attempting to reconnect to the AP 110. The STA1 initiates the targeted scan by broadcasting a probe request on channel N (e.g., the saved channel) at time t₀. As described above, channel N represents the channel on which the STA1 had prior communications with the AP 110. Therefore, the STA1 may expect to find the AP 110 on channel N. The STA1 then remains on channel N for an extended dwell time (e.g., from time t₁ to t₄), after broadcasting the probe request, to listen for a probe response from the AP 110.

The extended dwell time is longer than a standard dwell time (e.g., from time t₁ to t₂) of the STA1. In other words, the STA1 may typically expect to receive a probe response from the AP 110 at time t₁. However, due to channel congestion and/or other sources of delay, the actual probe response may not be received until time t₃ (e.g., after the standard dwell time has expired). Thus, if STA1 was not performing a targeted scan operation in accordance with the present embodiments (e.g., performing a full scan instead), it would only remain on channel N for the duration of the standard dwell time (e.g., until time t₂), and would therefore miss the probe response from the AP 110. However, because the STA1 “expects” to receive a probe response from the AP 110 via channel N (e.g., there is a greater likelihood of finding a saved-profile AP on a saved channel), it may be reasonable to remain on the channel for an extended duration to listen for the probe response. Accordingly, the extended dwell time increases the likelihood that STA1 will receive a probe response from the AP 110 (e.g., and/or another saved-profile AP), particularly when there may be congestion and/or interference on the channel.

In some instances, the STA1 may fail to receive a probe response from the AP 110 even after the extended dwell time expires (e.g., at time t₄). For example, the congestion or interference on the channel (e.g., channel N) may be too severe, or the STA1 may not be within communication range of the AP 110. If the STA1 does not receive a probe response by the end of the extended dwell time, it may proceed to scan another channel. For some embodiments, the order of scanning may be prioritized based on the saved channel information stored by the STA1. More specifically, the STA1 may scan the saved channels (e.g., for saved-profile APs) before scanning the remaining wireless channels.

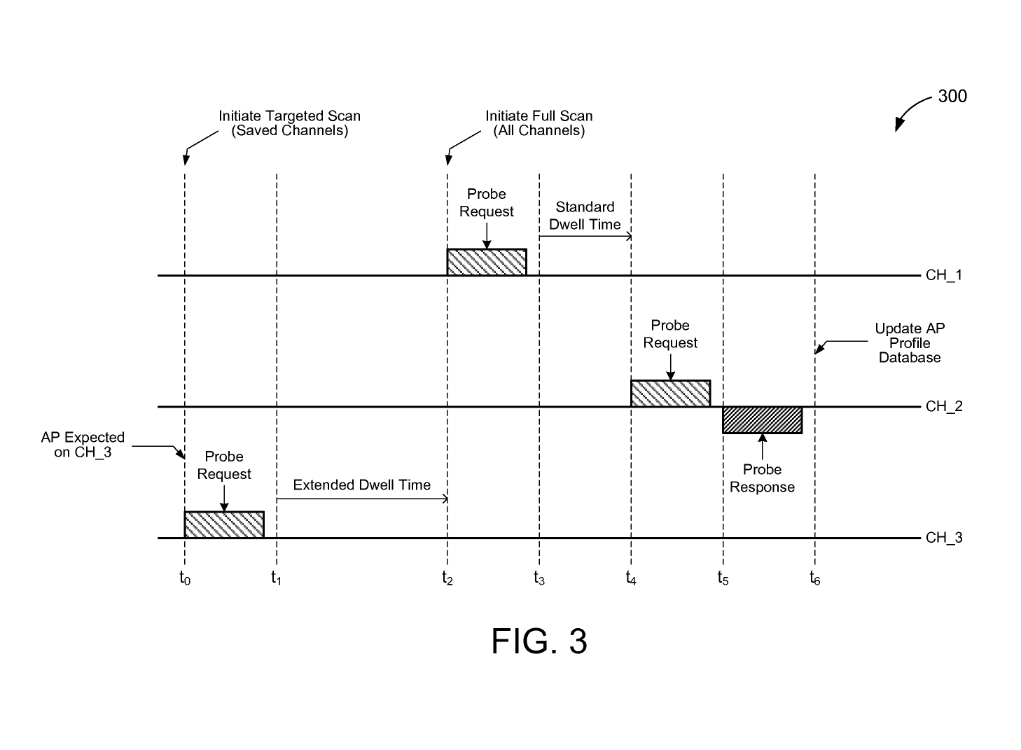

FIG. 3 is an exemplary timing diagram 300 illustrating a dynamic scan operation performed by a STA, in accordance with some embodiments. A STA may perform the dynamic scan operation, at time t₀, by first initiating a targeted scan on one or more saved channels. In the example shown, a saved-profile AP is expected to reside on channel 3. Thus, the STA broadcasts a probe request on channel 3, at time t₀, and remains on the channel for the duration of an extended dwell time (e.g., from time t₁ to t₂) to listen for a probe response from a corresponding AP. Because the STA does not receive a probe response by the end of the extended dwell time, it may then move on to another channel. At this point, the STA may perform a targeted scan on another saved channel (if available). However, in this example, the STA does not have any additional saved channel information stored in memory or otherwise accessible (e.g., from another source). Thus, the STA may subsequently initiate a full scan of all available channels at time t₂.

For some embodiments, the STA may scan only the remaining (e.g., previously unscanned) channels when performing the full scan. This may be a more efficient approach since any saved channels have already been scanned during the targeted scan period (e.g., from time t₀ to t₂). Thus, rescanning the saved channels may be redundant and time consuming. For other embodiments, the STA may scan all available channels, including the saved channels, when performing the full scan. This may be a more robust approach since it is possible that the STA failed to receive a probe response during the targeted scan due to congestion and/or interference on the channel at that time. Thus, rescanning the saved channels further increases the likelihood of detecting a saved-profile AP.

The STA performs the full scan by broadcasting a probe request on channel 1 at time t₂. The STA then remains on the channel for the duration of a standard dwell time (e.g., from time t₃ to t₄) to listen for a probe response from a corresponding AP. Because the STA does not receive a probe response by the end of the standard dwell time, at time t₄, it then proceeds by broadcasting a probe request on the next available channel (e.g., channel 2). The STA subsequently receives a probe response, at time t₅, before the standard dwell time expires (e.g., at time t₆). Thus, the STA may use the information included in the probe response to establish a connection with a corresponding AP residing on channel 2. For some embodiments, the STA may further update an AP profile database by storing AP profile information (e.g., saved channel information, SSID, PSK, key management information, priority information, etc.) to facilitate subsequent connections to the AP on channel 2.

The dynamic scan operation described above may significantly reduce the overall time needed to establish communications with an AP. More specifically, prioritizing the scanning of saved channels may reduce the time needed to locate an AP since there is a greater likelihood of finding a saved-profile AP on one of the saved channels. Moreover, increasing the dwell time when scanning the saved channels increases the likelihood of receiving a probe response from a corresponding AP. This may further reduce the number of rescans that need to be performed by the STA.

For some embodiments, a STA may further improve its chances of receiving a probe response from a saved-profile AP by enabling the AP to continuously transmit (and retransmit) probe responses to the STA over the duration of the dwell time. For example, the STA may notify the AP of its dwell time (e.g., either the standard dwell time or extended dwell time) when broadcasting probe requests on a given channel. More specifically, the dwell time information may be encoded or otherwise included as a vendor-specific information element (VSIE) of the probe request. A corresponding AP may determine the dwell time of the STA from the VSIE included in a received probe request, and may continuously transmit (and retransmit) a probe response to the STA for the duration of the dwell time (e.g., until the dwell time expires). This may further increase the likelihood that the STA will receive at least a copy of the probe response while remaining on the AP's channel.

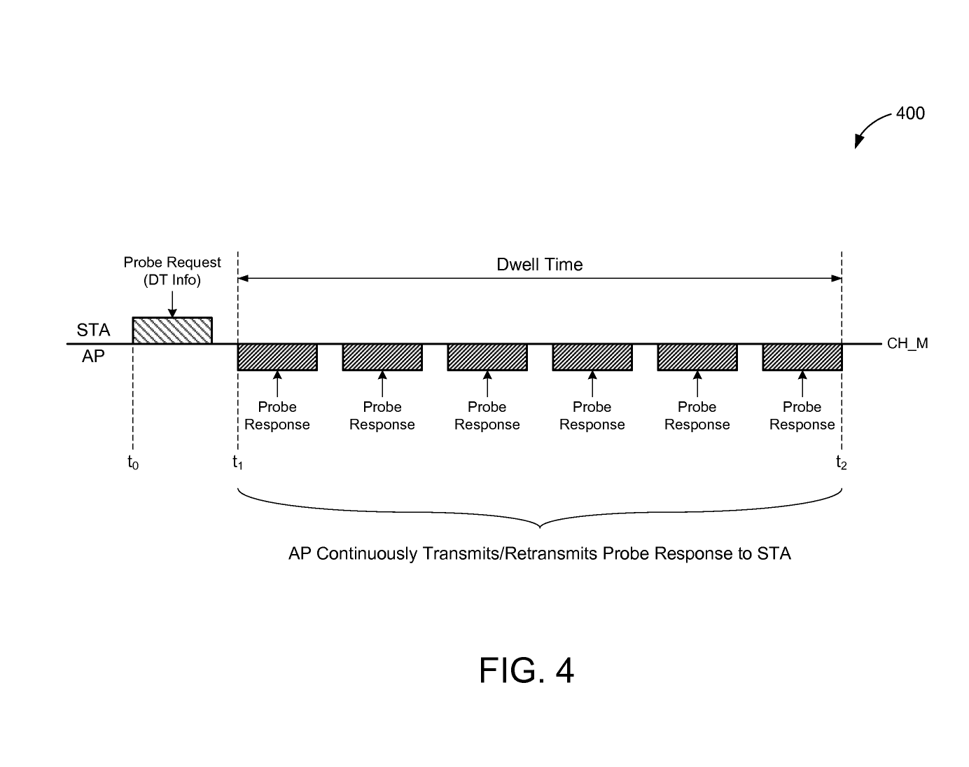

FIG. 4 is an exemplary timing diagram 400 illustrating a modified channel scan, in accordance with some embodiments. A STA may perform the modified channel scan when scanning saved channels (e.g., in conjunction with a targeted scan) and/or other wireless channels (e.g., in conjunction with a full scan). Specifically, the STA initiates the modified channel scan by broadcasting a probe request on channel M (e.g., which may be any available wireless channel) at time t₀. The probe request includes dwell time information (DT Info) indicating a dwell time of the STA associated with that particular channel (e.g., channel M). For example, the dwell time information may specify either an extended dwell time (e.g., if channel M is a saved channel) or a standard dwell time (e.g., if channel M is not a saved channel). For some embodiments, the dwell time information may be included as a VSIE within a corresponding probe request frame.

Still further, for some embodiments, the VSIE may additionally include the channel number and/or SSID of a saved-profile AP that the STA intends to connect to. For example, upon receiving a probe request the AP may compare the channel number and/or SSID included in the VSIE with its own channel number and SSID to determine whether to respond to the STA. For some embodiments, the AP may generate a corresponding probe response only if the channel number and SSID included in the probe request match its own channel number and SSID. This allows other APs that are not the intended recipient of the probe request to ignore the probe request altogether.

The AP then determines the dwell time of the STA (e.g., from time t₁ to t₂) based on the dwell time information included with the probe request and begins transmitting a probe response to the STA at time t₁. For some embodiments, the AP may continuously transmit (and retransmit) the probe response (e.g., which may include multiple copies of the same probe response) to the STA until the dwell time expires, at time t₂. This may significantly increase the likelihood that the STA will receive at least one of the probe responses within the duration of its dwell time (e.g., from time t₁ to t₂).

Under current IEEE 802.11 standards, STAs are not configured to acknowledge probe response frames. Thus, an AP typically has no knowledge of whether a probe response frame was received by an intended recipient STA. Without knowing otherwise, the AP may continuously transmit probe responses to the STA even after the STA has already received the probe response. This may consume significant bandwidth and/or processing power by the AP that could be better spent serving other clients and/or processes. Thus, for some embodiments, the AP may request confirmation of a received probe response by the STA. For example, the AP may encapsulate the probe response in an action frame that is then transmitted back to the STA (e.g., in lieu of a typical probe response frame). More specifically, the AP may encode or otherwise include the probe response information (e.g., the information that would typically be included in a probe response frame) in a new action frame. Unlike probe response frames, STAs are typically configured to confirm receipt of action frames by transmitting an acknowledgement (ACK) frame back to the AP.

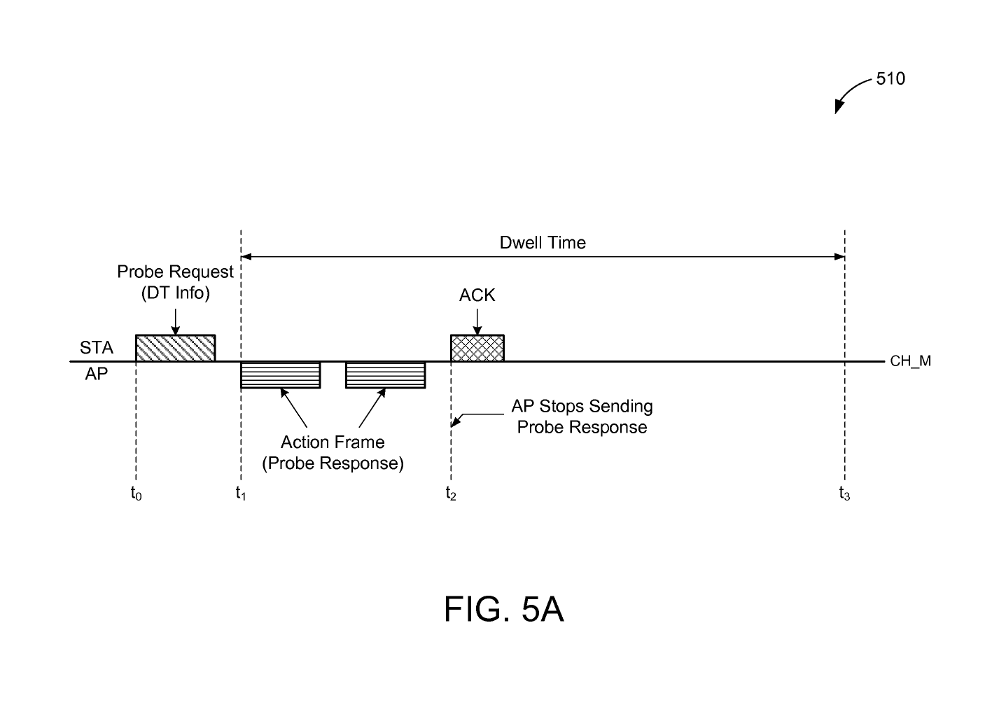

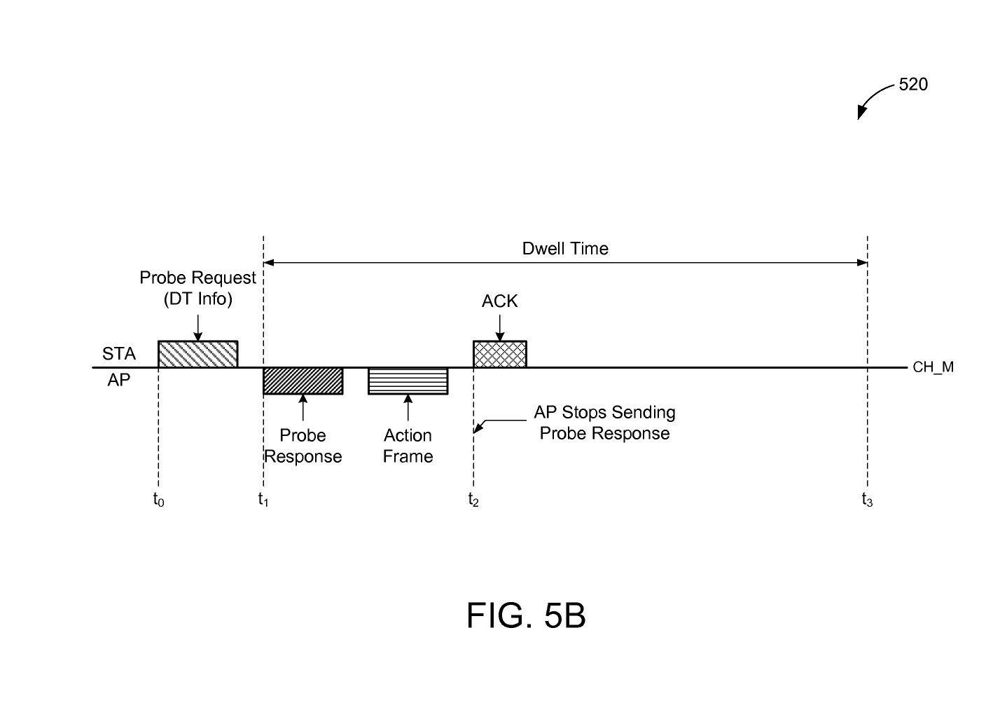

FIG. 5A is an exemplary timing diagram 510 illustrating a modified channel scan, in accordance with other embodiments. A STA initiates the modified scan by broadcasting a probe request on channel M (e.g., which may be any available wireless channel) at time t₀. As described above, the probe request may include dwell time information (DT Info) indicating a dwell time of the STA associated with that particular channel (e.g., channel M). For example, the dwell time information may specify either an extended dwell time (e.g., if channel M is a saved channel) or a standard dwell time (e.g., if channel M is not a saved channel). For some embodiments, the dwell time information may be included as a VSIE of the probe request.

Still further, for some embodiments, the VSIE may additionally include the channel number and/or SSID of a saved-profile AP that the STA intends to connect to. As described above, the AP may compare the channel number and/or SSID included with the VSIE with its own channel number and SSID to determine whether to respond to the STA. For some embodiments, the AP may generate a corresponding probe response only if the channel number and SSID included in the probe request match its own channel number and SSID, respectively.

The AP then determines the dwell time of the STA (e.g., from time t₁ to t₂) based on the dwell time information included with the probe request, and generates a probe response to be sent back to the STA. For some embodiments, the AP may further encapsulate the probe response in an action frame and transmit the action frame back to the STA at time t₁. For some embodiments, the AP may continuously transmit (and retransmit) the action frame (e.g., which includes the probe response information) to the STA until the dwell time expires (e.g., at time t₃) or an acknowledgement is received from the STA (e.g., whichever comes first). In the example shown, the STA transmits an ACK frame to the AP (e.g., to confirm receipt of an action frame) at time t₂. Thus, the AP may stop sending action frames to the STA at this time, and may instead devote its resources to other tasks for the remainder of the dwell time (e.g., from time t₂ to t₃).

In an alternative embodiment, the AP may respond to a probe request by transmitting (and retransmitting) a standard probe response frame followed by an action frame. The action frame may be empty or “null.” For example, this may still cause the STA to confirm receipt of a probe response (e.g., by acknowledging the subsequent action frame), but does not require the STA to parse the action frame for probe response information. Accordingly, such embodiment may be implemented with fewer modifications to the existing network architecture.

FIG. 5B is an exemplary timing diagram 520 illustrating a modified channel scan, in accordance with yet another embodiment. The modified channel scan of FIG. 5B is substantially similar to the modified channel scan depicted in FIG. 5A, with the exception of the AP transmitting the probe response separate from the action frame. For example, the STA may initiate the modified scan by broadcasting a probe request on channel M at time t₀. The probe request may include dwell time information (DT Info) which the AP uses to determine a corresponding dwell time of the STA for that channel (e.g., channel M).

The AP then begins transmitting a probe response frame, followed by an action frame (e.g., which may be empty or null), to the STA at time t₁. For some embodiments, the AP may continuously transmit (and retransmit) the probe response frame followed by the action frame until the dwell time expires (e.g., at time t₃) or an acknowledgement is received from the STA (e.g., whichever comes first). In the example shown, the STA transmits an ACK frame to the AP (e.g., to confirm receipt of the action frame) at time t₂. Thus, the AP may stop sending probe response frames (and action frames) to the STA at this time, and may instead devote its resources to other tasks for the reminder of the dwell time (e.g., from time t₂ to t₃).

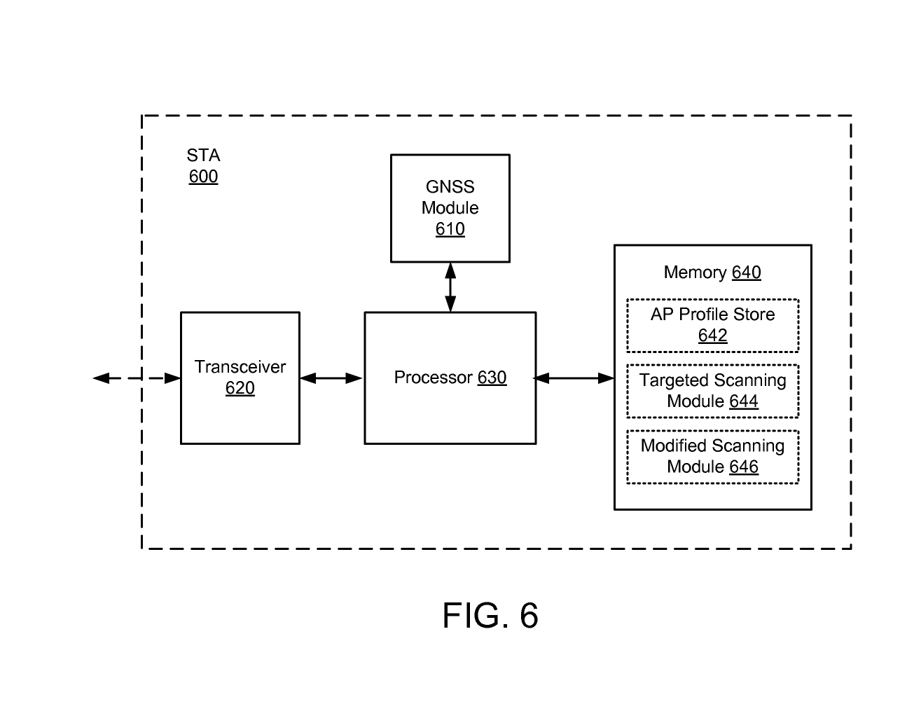

FIG. 6 shows a block diagram of a wireless STA 600 in accordance with some embodiments. Specifically, the STA 600 may be one embodiment of at least one of the stations STA1-STA3 of FIG. 1. The STA 600 may include, but is not limited to, a global navigation satellite system (GNSS) module 610, a transceiver 620, a processor 630, and a memory 640. The transceiver 620 may be used to transmit signals to and receive signals from the AP 110 and/or other STAs. In addition, the transceiver 620 can be used to scan the surrounding environment to detect and identify nearby access points (e.g., access points within wireless communication range of the STA 600) and/or other STAs. For some embodiments, the transceiver 620 can be used to search for nearby access points by periodically transmitting MAC address request frames (e.g., probe requests). The GNSS module 600 can be used to determine the current location of the STA 600, for example, using triangulation techniques.

Memory 640 may include an AP profile store 642 that stores AP profile information for a number of WLANs and/or APs. More specifically, the AP profile store 642 may include a plurality of storage locations, each for storing at least a channel number and SSID associated with the corresponding APs and/or WLANs. The profile store 642 may include additional profile information such as, for example, a pre-shared key (PSK), key management information, and/or priority information associated with the corresponding APs and/or WLANs. For some embodiments, the AP profile store 642 may be pre-populated (e.g., loaded with predetermined channel numbers and SSIDs). For other embodiments, the AP profile store 642 may include AP profile information corresponding to APs and/or WLANs with which the STA 600 has been previously associated.

Memory 640 may also include a non-transitory computer-readable medium (e.g., one or more nonvolatile memory elements, such as EPROM, EEPROM, Flash memory, a hard drive, and so on) that can store the following software modules:
a targeted scanning module 644 to selectively scan a number of the saved channels stored in the AP profile store 642, and to enable the STA 600 to remain on each saved channel for an extended duration when listening for a probe response from a corresponding AP; and
a modified scanning module 646 to encode a dwell time of the STA 600 for a given channel and/or AP profile information for an intended AP into probe requests to be broadcast on that channel.
   Each software module includes instructions that, when executed by processor 630, causes STA 600 to perform the corresponding functions. The non-transitory computer-readable medium of memory 640 thus includes instructions for performing all or a portion of the operations described below with respect to FIGS. 8 and 10.

Processor 630, which is shown in the example of FIG. 6 as coupled to transceiver 620, GNSS module 610, and memory 640, may be any suitable processor capable of executing scripts or instructions of one or more software programs stored in STA 600 (e.g., within memory 640). For example, processor 630 may execute the targeted scanning module 644 to selectively scan a number of the saved channels stored in the AP profile store 642, and to enable the STA 600 to remain on each saved channel for an extended duration when listening for a probe response from a corresponding AP. Processor 630 may also execute the modified scanning module 646 to encode a dwell time of the STA 600 for a given channel and/or AP profile information for an intended AP into probe requests to be broadcast on that channel.

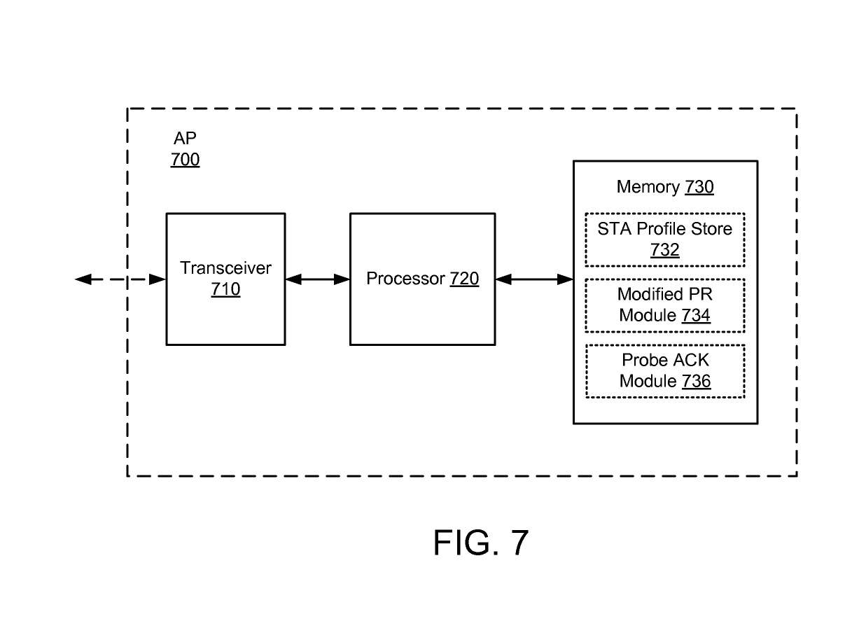

FIG. 7 shows an AP 700 that is one embodiment of the AP 110 of FIG. 1. The AP 700 includes a transceiver 710, a processor 720, and a memory 730. The transceiver 710 may be used to communicate wirelessly with one or more STAs, with one or more other APs, and/or with other suitable wireless devices. Processor 720, which is coupled to transceiver 710 and memory 730, may be any suitable processor capable of executing scripts or instructions of one or more software programs stored in the AP 700 (e.g., within memory 730). Although not shown for simplicity, the AP 700 may also include a network interface to communicate with a WLAN server (not shown for simplicity) associated with the WLAN 120 of FIG. 1 either directly or via one or more intervening networks, and to transmit signals.

Memory 730 may include a STA profile store 732 that stores information (e.g., capabilities) of a number of STAs currently and/or previously associated with the AP 700. Memory 730 may also include a non-transitory computer-readable medium (e.g., one or more nonvolatile memory elements, such as EPROM, EEPROM, Flash memory, a hard drive, and so on) that may store the following software modules:
a modified probe response (PR) module 734 to selectively generate a probe response based on AP profile information included in a probe request from a corresponding STA, and/or to continuously transmit the probe response to the STA for the duration of a dwell time indicated by the probe request; and
a probe acknowledgement (ACK) module 736 to request confirmation of the probe response by the STA, for example, by encapsulating the probe response in an action frame or by transmitting an action frame to the STA in conjunction with a probe response frame.
   Each software module includes instructions that, when executed by processor 720, causes the AP 700 to perform the corresponding functions. The non-transitory computer-readable medium of memory 730 thus includes instructions for performing all or a portion of the operations described below with respect to FIGS. 9 and 10.

Processor 720, which is shown in the example of FIG. 7 as coupled to transceiver 710 and memory 730, may be any suitable processor capable of executing scripts or instructions of one or more software programs stored in AP 700 (e.g., within memory 730). For example, processor 720 may execute the modified PR module 734 to selectively generate a probe response based on AP profile information included in a probe request from a corresponding STA, and/or to continuously transmit the probe response to the STA for the duration of a dwell time indicated by the probe request. Processor 720 may also execute the probe ACK module 736 to request confirmation of the probe response by the STA, for example, by encapsulating the probe response in an action frame or by transmitting an action frame to the STA in conjunction with a probe response frame.

FIG. 8 shows an illustrative flow chart depicting a dynamic scan operation 800 performed by a STA, in accordance with some embodiments. For example, with reference to FIG. 1, the dynamic scan operation 800 may be implemented by STA1 when attempting to reconnect to the AP 110. Specifically, a STA may first broadcast a probe request on a saved channel (810). For example, each saved channel (e.g., channel number) may correspond with a particular wireless channel over which the STA had prior communications with an AP (e.g., a saved-profile AP). As described above, when a STA becomes associated with an AP, the STA may store AP profile information (e.g., channel number, SSID, PSK, key management information, priority information, etc.) in memory to facilitate subsequent connections to that AP. Thus, each of the saved channels may be associated with a saved-profile AP to which the STA was previously connected.

The STA then remains on the current saved channel for an extended duration to listen for a probe response from the AP (820). As described above, each saved channel is a wireless channel on which the STA reasonably expects to find a saved-profile AP (e.g., due to having prior communications with the AP over that channel). Thus, it may be reasonable for the STA to remain on the saved channel for an extended duration (e.g., longer than the standard dwell time of the STA) in order to ensure that the STA does not miss a probe response from the AP that arrives later than expected (e.g., due to channel congestion or interference and/or other sources of delay).

For some embodiments, the STA may indicate its dwell time to the AP on the current saved channel. For example, the STA may transmit a modified probe request which includes dwell time information indicating the dwell time of the STA for that particular channel. This may enable a corresponding AP to continuously transmit (and retransmit) probe responses back to the STA for the duration of its dwell time. For some embodiments, the dwell time information may be included as a VSIE within a corresponding probe request frame. Still further, for some embodiments, the VSIE may additionally include the channel number and/or SSID of a saved-profile AP that the STA intends to connect to. This may enable other APs that are not the intended recipient of the probe request to ignore the probe request altogether.

If the STA receives a probe response from an AP (830), it may subsequently establish a connection with that AP (870). For example, the STA may connect to the AP using information provided in the probe response. However, if the STA does not receive a probe response by the expiration of the extended dwell time, the STA may move on to the next channel. If there are remaining unscanned saved channels (840), the STA may then broadcast a probe request on the next saved channel in the set (860). Again, the STA remains on the current saved channel for the extended duration to listen for a probe response from a saved-profile AP (820).

If no probe response is received after all saved channels have been scanned (840), the STA may subsequently perform a full scan of all available channels (850). For some embodiments, the STA may scan only the remaining (e.g., unscanned) channels when performing the full channel scan. For example, this may be a more efficient approach since any saved channels have already been scanned up to this point. For other embodiments, the STA may scan all available channels, including the saved channels, when performing the full channel scan. For example, this may be a more robust approach since it further increases the likelihood of detecting a saved-profile AP that may have been missed during an earlier scan.

FIG. 9 shows an illustrative flow chart depicting a method 900 of operating an AP during a modified scan operation, in accordance with some embodiments. For example, with reference to FIG. 1, the method 900 may be performed by the AP 110 when responding to probe requests broadcast by one or more of the stations STA1-STA3. Specifically, an AP may first receive a probe request from a STA (910). The probe request may include AP profile information associated with a particular AP that is the intended recipient of the probe request. For example, the AP profile information may include the channel number and/or SSID of the intended AP as well as a dwell time of the STA for the associated channel. For some embodiments, the AP profile information may be included as a VSIE within a corresponding probe request frame.

The AP compares the channel number and SSID included in the probe request with its own channel number and SSID (920) to determine whether it is the intended recipient of that probe request. If either the channel number from the probe request does not match the channel number on which the AP currently resides or the SSID from the probe request does not match the SSID of the AP (930), the AP may simply ignore the probe request (935). However, if both the channel number and SSID from the probe request match that of the AP (930), the AP may then determine the dwell time of the STA which transmitted the probe request (940). For example, the AP may determine the dwell time of the STA from the dwell time information included in the probe request. More specifically, the dwell time information may specify either a standard dwell time (e.g., if the STA is performing a full channel scan) or an extended dwell time (e.g., if the STA is performing a targeted scan).

The AP may then generate a probe response (950), and transmit the probe response with an action frame to the STA (960). For example, the probe response may mirror the information provided in the probe request intersected with the capabilities supported by the AP. Furthermore, the action frame causes the STA to confirm receipt of the probe response, for example, by sending an ACK frame back to the AP. For some embodiments, the probe response may be encapsulated in the action frame that is sent back to the STA (e.g., as described above with respect to FIG. 5A). For other embodiments, the probe response may be sent as a separate probe response frame that is independent of the action frame (e.g., as described above with respect to FIG. 5B).

After sending the probe response and action frame to the STA, the AP listens for an acknowledgement from the STA. If the AP receives a subsequent ACK frame (970), it may then establish a connection with the STA. However, if no ACK frame is received (970), and the dwell time has not expired (980), the AP may transmit another probe response and action frame to the STA (960). More specifically, the AP may continuously transmit action frames with probe responses to the STA (960) until it receives an ACK frame from the STA (970) or the dwell time expires (980). When the dwell time expires (980), it is likely that the STA is no longer listening to the current channel. Thus, the AP may stop transmitting the probe response to the STA (990).

FIG. 10 shows an illustrative flow chart depicting a modified scan operation 1000, in accordance with some embodiments. A STA first identifies a channel to be scanned (1001). For example, the channel may correspond to a saved channel (e.g., if the STA is performing a targeted scan) or any other channel (e.g., if the STA is performing a full channel scan). The STA then encodes a probe request with its dwell time information (1002), and broadcasts the probe request on the identified channel (1003). For example, the dwell time information may indicate a dwell time (e.g., standard dwell time or extended dwell time) of the STA for the identified channel. For some embodiments, the STA may additionally encode AP profile information (e.g., channel number and/or SSID) associated with an intended recipient AP (e.g., when scanning for a saved-profile AP).

The AP receives the probe request (1004), and begins transmitting a probe response with an action frame back to the STA (1005). More specifically, the AP may continuously transmit (and retransmit) the probe response with the action frame for the duration of the dwell time or until an acknowledgment is received from the STA. For example, the AP may determine the dwell time of the STA from the dwell time information included in the probe request. For some embodiments, the probe response may be encapsulated in the action frame that is sent back to the STA. For other embodiments, the probe response may be sent as a separate probe response frame that is independent of the action frame.

The STA receives the probe response (1006), and transmits an ACK frame back to the AP in response to the action frame (1007). For some embodiments, the STA may analyze the received action frame for probe response information. For other embodiments, the STA may simply receive an empty action frame following a probe response frame. As described above, and in accordance with existing IEEE 802.11 standards, a STA is typically configured to confirm receipt of an action frames by transmitting an ACK frame back to the AP.

The AP receives the ACK frame from the STA (1009) and subsequently ceases transmission of the probe response to the STA (1010). This allows the AP to serve other devices and/or processes during the remainder of a duration (e.g., corresponding to the dwell time of the STA) that would otherwise be allocated to transmitting (and retransmitting) probe responses to the STA. Moreover, at this point, the STA may use the information included in the probe response to establish (or re-establish) a connection to the AP (1010). For some embodiments, the STA may further update the AP profile information stored in memory to reflect the most recent connection (or reconnection) to an AP.

In the foregoing specification, the present embodiments have been described with reference to specific exemplary embodiments thereof. It will, however, be evident that various modifications and changes may be made thereto without departing from the broader scope of the disclosure as set forth in the appended claims. For example, the method steps depicted in the flow charts of FIGS. 8-10 may be performed in other suitable orders, multiple steps may be combined into a single step, and/or some steps may be omitted. The specification and drawings are, accordingly, to be regarded in an illustrative sense rather than a restrictive sense.

What is claimed is:

1. A method for a station (STA) to scan for access points (APs), the method comprising:
broadcasting a probe request on a first saved channel of one or more saved channels, wherein the STA received prior communications on each of the one or more saved channels; and
remaining on the first saved channel for an extended duration to listen for a probe response from a first AP, wherein the extended duration is greater than a dwell time of the STA when scanning wireless channels other than the one or more saved channels.

2. The method of claim 1, further comprising:
if the probe response is not received within the extended duration:
determining that a second saved channel of the one or more saved channels has not yet been scanned;
broadcasting a probe request on the second saved channel; and
remaining on the second saved channel for the extended duration to listen for a probe response.

3. The method of claim 1, further comprising:
if the probe response is not received within the extended duration:
determining that all of the one or more saved channels have been scanned;
broadcasting a probe request on a first wireless channel that is not among the one or more saved channels; and
remaining on the first wireless channel for a first duration to listen for a probe response, wherein the first duration is equal to the dwell time.

4. The method of claim 1, wherein the probe request includes information specifying a length of the extended duration.

5. The method of claim 4, wherein the first AP repeatedly transmits the probe response to the STA for the length of the extended duration.

6. The method of claim 5, further comprising:
receiving the probe response from the first AP; and
transmitting an acknowledgment (ACK) frame to the first AP upon receiving the probe response.

7. The method of claim 6, wherein the probe response is encapsulated in an action frame.

8. The method of claim 6, wherein the first AP stops transmitting the probe response upon receiving the ACK frame from the STA.

9. The method of claim 1, wherein the first AP is associated with the first saved channel.

10. A method of operating an access point (AP), the method comprising:
receiving a probe request from a station (STA), wherein the probe request includes information identifying a first channel number and a first service set identifier (SSID);
comparing the first channel number and the first SSID with a respective channel number and SSID associated with the AP; and
selectively transmitting a probe response to the STA based on the comparison.

11. The method of claim 10, wherein selectively transmitting the probe response comprises:
transmitting the probe response if the first channel number matches the channel number associated with the AP and the first SSID matches the SSID associated with the AP.

12. The method of claim 11, wherein transmitting the probe response comprises:
encapsulating the probe response in an action frame; and
transmitting the action frame to the STA.

13. The method of claim 11, wherein the probe request further includes information specifying a dwell time of the STA for the first channel.

14. The method of claim 13, wherein transmitting the probe response comprises:
repeatedly transmitting the probe response to the STA for the length of the dwell time.

15. The method of claim 14, further comprising:
receiving an acknowledgement (ACK) frame from the STA; and
ceasing transmission of the probe response upon receiving the ACK frame from the STA.

16. A wireless device, comprising:
a memory element to store instructions for scanning for access points (APs); and
one or more processors that, upon executing the instructions, cause the wireless device to:
broadcast a probe request on a first saved channel of the one or more saved channels, wherein the wireless device received prior communications on each of the one or more saved channels; and
remain on the first saved channel for an extended duration to listen for a probe response from a first AP, wherein the extended duration is greater than a dwell time of the wireless device when scanning wireless channels other than the one or more saved channels.

17. The wireless device of claim 16, wherein, if the probe response is not received within the extended duration, execution of the instructions further causes the wireless device to:
determine that a second saved channel of the one or more saved channels has not yet been scanned;
broadcast a probe request on the second saved channel; and
remain on the second saved channel for the extended duration to listen for a probe response.

18. The wireless device of claim 16, wherein, if the probe response is not received within the extended duration, execution of the instructions further causes the computing device to:
determine that all of the one or more saved channels have been scanned;
broadcast a probe request on a first wireless channel that is not among the one or more saved channels; and
remain on the first wireless channel for a first duration to listen for a probe response, wherein the first duration is equal to the dwell time.

19. The wireless device of claim 16, wherein the probe request includes information specifying a length of the extended duration

20. The wireless device of claim 16, wherein execution of the instructions further causes the wireless device to:
transmit an acknowledgement (ACK) frame to the first AP upon receiving the probe response, wherein the probe response is encapsulated in an action frame transmitted by the first AP.
